(19) United States
(12) Patent Application Publication
(10) Pub. No.: US 2009/0293263 A1
(43) Pub. Date: Dec. 3, 2009

(54) Premo rock-out

(76) Inventors: Dalton J. Primeaux, SR., Raceland, LA (US); Eddie N. Primeaux, Westwego, LA (US)

Correspondence Address: Dalton J. Primeaux Sr., 806 N. Service Rd., Raceland, LA, 70394, US

(21) Appl. No.: 12/156,721

(22) Filed: Jun. 3, 2008

(51) Int. Cl. B23P 19/04

(52) U.S. Cl. 29/700

(57) ABSTRACT

The present invention comprises the guide plate, two guide pins and a knock plate with four connected blades. This tool is a precise, quick and dust free cutting device. It is used to remove the cut out for utility box in wall board installation. The guide pins are inserted into already installed utility box screw openings. When wall board is put into position, guide pins will pierce through board locating the utility box. The guide plate is then placed over pins to direct knock plate in the right position. The knock plate has metal blades that will cut through wall board, allowing easy location and cutting of wall board.

### BACKGROUND OF THE INVENTION

1. Field of Invention

This invention relates to utility boxes, and particularly to means and methods for locating and cutting opening for utility boxes mounted behind wallboard during the construction of buildings.

In the construction of buildings and building rooms a wooden frame is typically used. Once frame has been erected wiring, water pipes and gas lines are mounted to studs. The electrical wiring ideally extends to a series of utility boxes that are mounted to studs. Utility boxes have an opening, which once wall board is used will cover the opening. Wall board usually comes in the form of four by eight sheets of sheetrock. Sheetrock is typically placed upright and nailed in place. The usual practice of construction worker is place sheetrock in position using few nails. Worker draws outline of utility box on reverse of wall board. Worker than removes nails, lays sheetrock down to cut out opening. Worker than remounts board, if all has gone as planed utility box opening will line up with sheetrock cut out.

The previous description of locating utility box is very time consuming. It is also very difficult to do with just one worker. Not to mention very dusty. Furthermore, constant handling of sheetrock can cause bending and chipping of board.

Therefore, the present invention will provide improved means, accuracy and speed for locating a utility box. This tool can be used in hospitals and other places where a dust free zone is desired. With this tool the cut is accurate.

You will not need any other tool for cutting. Often, the locating of a utility box is very time consuming and difficult with one worker. With this cutting tool it is time efficient and very easy to do with a one man crew

2. Description of the Prior Art

Numerous devices have been provided in the past. There have been devices that mark the wall. You have to then use your own means to cut out utility box opening. As in U.S. Pat. Nos. 6,055,736 and 4,209,103. With present invention you will be able to locate and cut in three easy steps.

### SUMMARY OF THE INVENTION

This invention was inspired by the problems of searching for utility box when installing wall board. Also, the need for minimal clean up. This invention provides a device that is quick, accurate and dust free. The tool will locate the utility box using the guide pins. Guide pins are place into screw holes of existing utility box. Sheetrock is put into position. Guide pins will pierce through board. Once, guide pins break through wall board the guide plate is placed over pins. Guide plate will steer blades into position. The cut will be precise using the guide plate as a guide. The knock plate has four blades that will fit over guide plate. Knock plate is then hammered on to penetrate through the wall board. Once, knock plate is hammered through wall board removal of knock plate is easy as well, just grab with hand on both sides of plate and pull. With this method you will have clean accurate cut.

These objects, and other uses of the present invention will become clear to those skilled in the art when the following description is read in conjunction with the accompanying drawings

### BRIEF DESCRIPTION OF THE DRAWINGS

FIG. 1 front view of guide pin

FIG. 2 top view of adjusting lock washer

FIG. 3A front view of guide plate.

FIG. 3B lateral view guide plate.

FIG. 4A lateral view of knock plate.

FIG. 4B top view of knock plate.

FIG. 4C front view of knock plate

FIG. 4D back view of knock plate.

FIG. 4E lateral view of knock plate with blade attached.

FIG. 4F top view of knock plate with blade attached.

FIG. 5 front view of drift pin.

FIG. 6 top view of side blade.

FIG. 7 top view of top and bottom blade.

FIG. 8 example of invention layout.

### DETAILED DESCRIPTION OF THE INVENTION

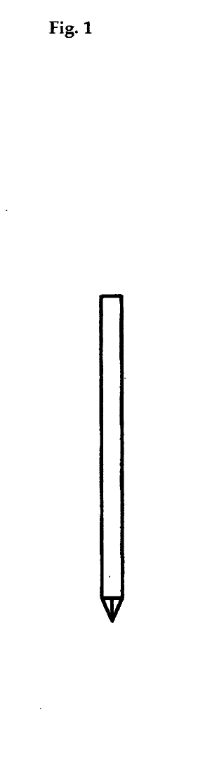

Referring to FIG. 1-8 in particular, the apparatus of the present invention will now be described.

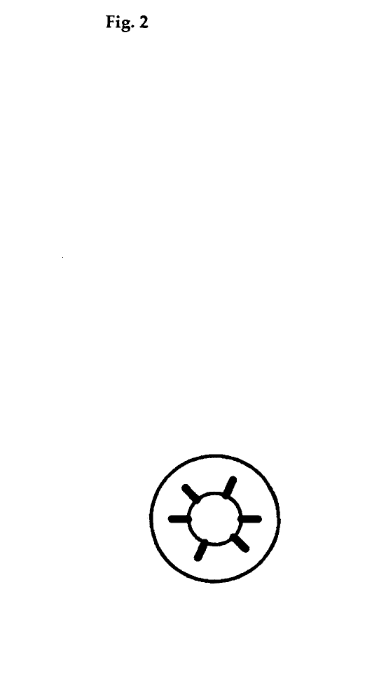

In FIGS. 1 and 2 the guide pins are made of a round mild steel rod with pointed tip. Round steel rod will have a adjusting lock steel washer on the middle of the round steel rod. Washer is placed on rod to set the depth of mild steel rod.

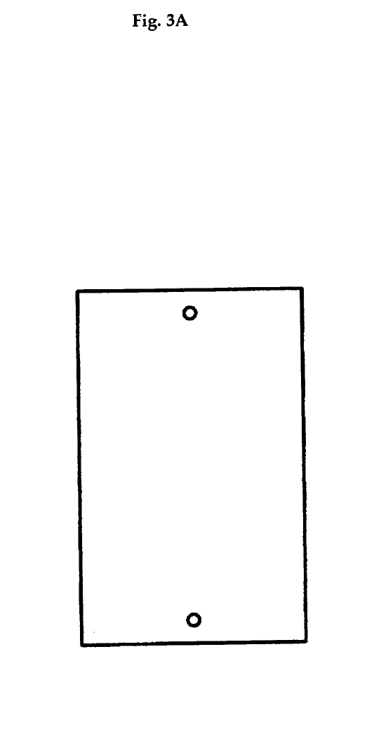

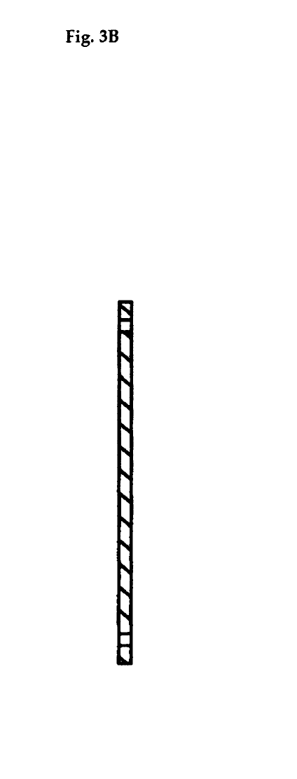

FIGS. 3A and 3B Is the guide plate comprised of a 1/16″ thick mild steel with two small holes on top and bottom. The holes are placed on the guide plate to rest over guide pins. The guide plate is used to steer the blades into position.

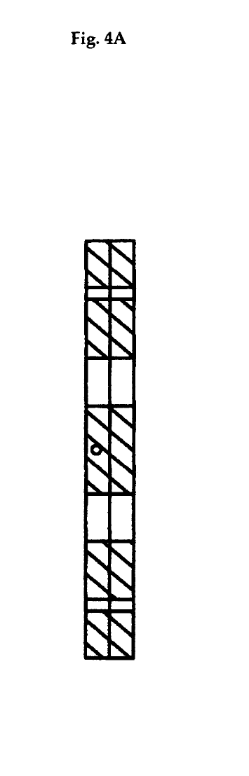

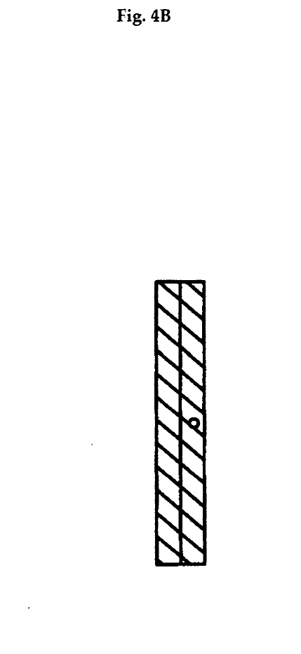

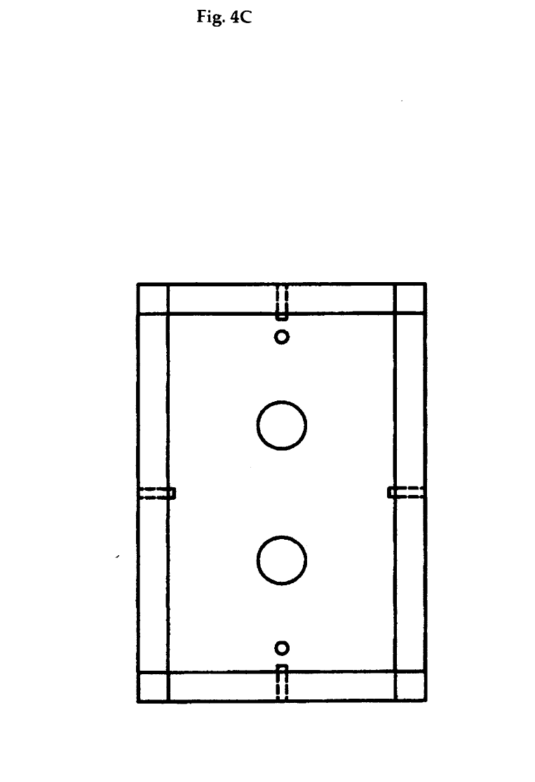

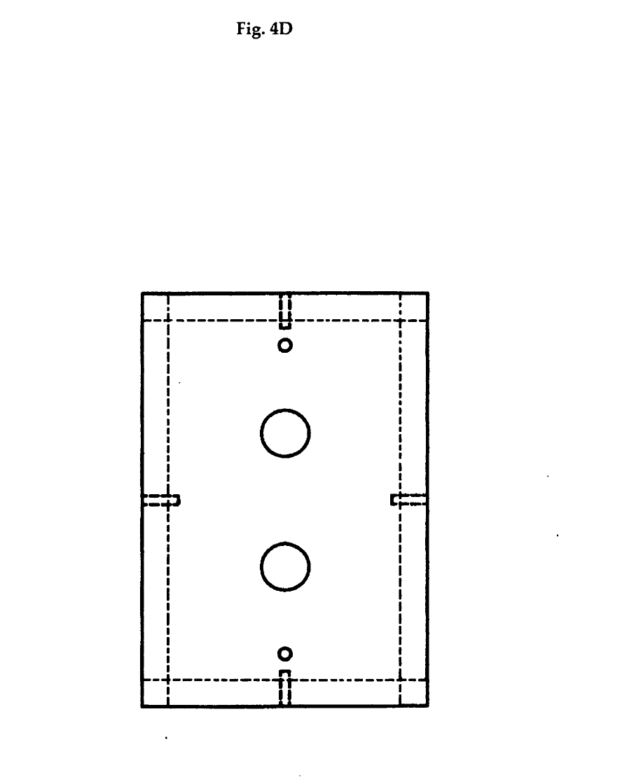

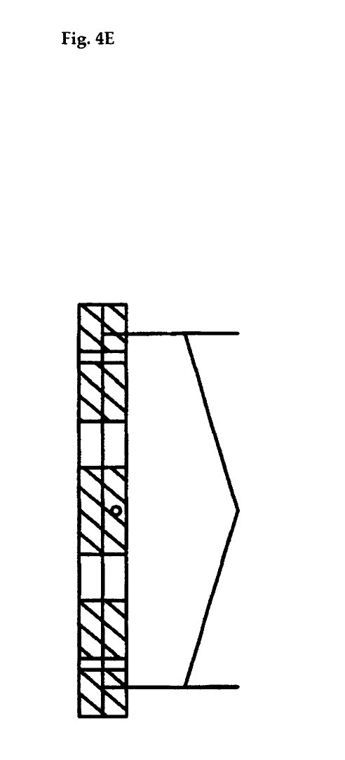

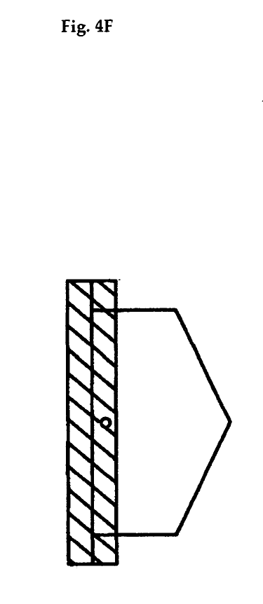

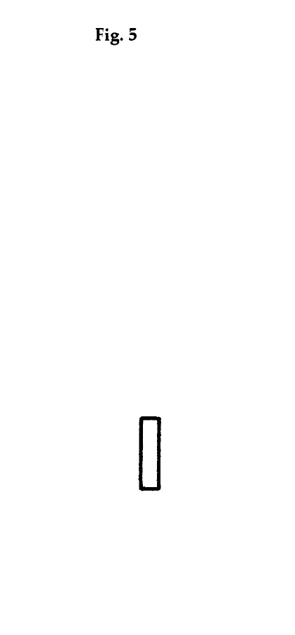

FIG. 4A-4F Is the knock plate which is made of a ½″ thick aluminum. The knock plate has four thin groove to insert the four blades as shown in FIG. 4C. Also, as in FIG. 4C-4F there are four drift pins (FIG. 5) that hold blade into position. There are two holes in knock plate. One hole at top one at bottom. Holes are used to remove cut out of wall board. Once, guide plate is in position blades fit over plate and hammer on knock plate to force blades through wall board. Blades will go through board with ease. Remove knockplate, utility box will then be exposed.

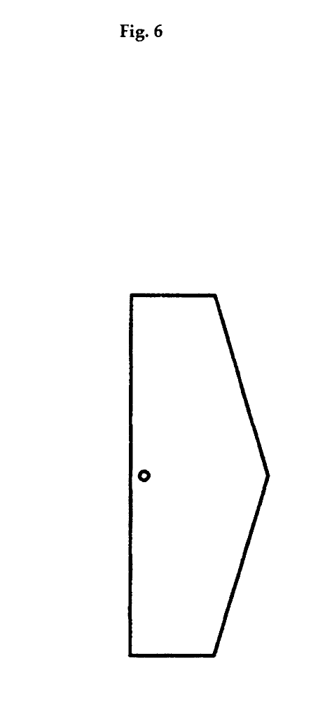

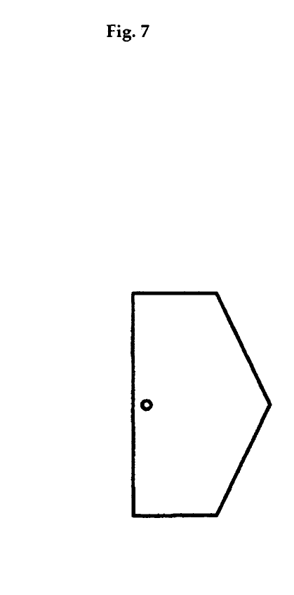

As shown in FIGS. 6 and 7 the cut on the spring steel will cut through sheetrock with ease. The blades are connected to knock plate.

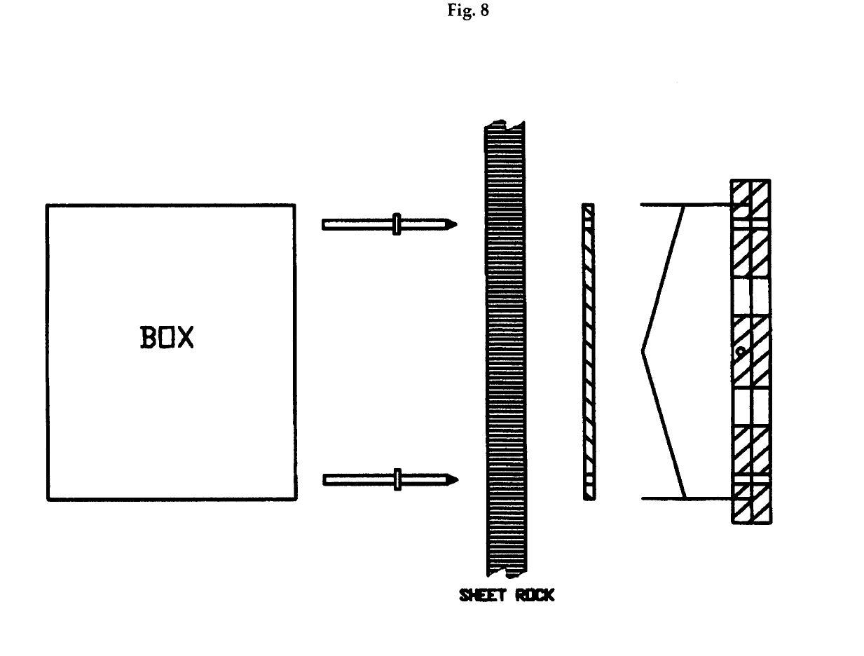

Referring to FIG. 8 this is showing the layout of the invention. Guide pins placed in screw holes of utility box. Sheetrock is hung. Guide pins penetrate through sheetrock. Guide plate is placed on pins. Blades fit over plate. Hammer on knock plate to drive blades through wall board. Remove knock plate.

What is claimed is:

1. A utility box will be located:
(a) a set of guide pins will be placed in existing utility box mounting holes.
(b) once wall board is hung guide pins will pierce through wall board locating the position of the utility box.
(c) as soon as guide pins pierce through wall board guide plate will rest on pins.
(d) guide plate will give an accurate location of utility box.
(e) guide plate will guide the blades of the knock plate to a precise cut.

2. Precise cut with minimal dust and little clean up.
(a) blades on knock plate fit over guide plate.
(b) knock plate is knocked through wall board using a hammer.
(c) once knock plate is removed precise clean cut revealing utility box.
